(19) United States
(12) Patent Application Publication
(10) Pub. No.: US 2017/0352878 A1
(43) Pub. Date: Dec. 7, 2017

(54) SILICON-CARBON COMPOSITE MATERIAL CONTAINING CARBON MATERIAL COMPRISING LAYERS

(71) Applicant: Panasonic Intellectual Property Management Co., Ltd., Osaka (JP)

(72) Inventor: SUSUMU KAJITA, NARA (JP)

(21) Appl. No.: 15/597,109

(22) Filed: May 16, 2017

(30) Foreign Application Priority Data
Jun. 1, 2016 (JP) 2016-110119

(51) Int. Cl. H01M 4/36; H01M 4/04; H01M 4/66; H01M 4/62; H01M 4/38; H01M 4/1395; H01M 4/1393; H01M 4/134; H01M 4/133; H01M 10/0525; H01M 4/587; H01M 4/02

(52) U.S. Cl. CPC H01M 4/366; H01M 10/0525; H01M 4/0404; H01M 4/0435; H01M 4/661; H01M 4/625; H01M 4/623; H01M 4/587; H01M 4/38; H01M 4/1395; H01M 4/1393; H01M 4/134; H01M 4/133; C01P 2006/40; C01P 2002/08; H01M 2004/027

(57) ABSTRACT

A silicon—carbon composite material contains: a carbon material comprising layers; and silicon particles supported between the layers of the carbon material. The specific surface area of the silicon—carbon composite material is 200 m²/g or more as determined by the BET method using nitrogen gas adsorption.

### BACKGROUND

### 1. Technical Field

The present disclosure relates to a silicon—carbon composite material and a method for producing the same.

### 2. Description of the Related Art

Composite materials containing silicon and a carbon material are negative electrode materials allowing lithium ion batteries to have high capacity and are under investigation. Silicon has a theoretical electrochemical capacity of 4,200 mAh/g (Li₂₂Si₅), whereas graphite widely used at present has a theoretical electrochemical capacity of 372 mAh/g (LiC₆). Thus, the electrochemical capacity of silicon is more than ten times of the theoretical electrochemical capacity of graphite. On the other hand, silicon absorbs lithium and the rate of change in volume of silicon is very high, 420%, when silicon forms Li₂₂Si₅. Therefore, in the electrode material, electrical connection failures are likely to occur between silicon particles and between carbon and the silicon particles. Since the diffusion of lithium ions in the silicon particles is slow, the concentration distribution of the lithium ions in the silicon particles is uneven and the silicon particles are destroyed in some cases.

In order to cope with electrical connection failures, it is investigated that a polymer is mixed with silicon particles and the silicon particles are coated with a carbon material by carbonizing the polymer or the silicon particles are covered with a carbon material by mechanical mixing. According to such a structure, electrical connections are unlikely to be broken even when the silicon particles expand.

In order to cope with the destruction of silicon particles, the nano-sizing (nm) of the silicon particles is under investigation. This enables the unevenness of the concentration distribution of lithium ions in the silicon particles to be reduced. For example, Japanese Unexamined Patent Application Publication (Translation of PCT Application) No. 2015-503185 (hereinafter referred to as the patent document) discloses a nano-silicon—carbon composite material, used as a negative electrode material for lithium ion batteries, containing a carbon matrix and nano-silicon dispersed thereon.

### SUMMARY

In the case of mixing nano-silicon with a carbon material, silicon particles are likely to aggregate. A non-uniform composite material is formed from partially aggregated silicon and the carbon material in some cases because of the aggregation of the silicon particles. Therefore, in the case where further stabilizing electrical connections and suppressing the destruction of silicon particles are required for a composite material containing the silicon particles and a carbon material, there is room for improvement in highly hybridizing the silicon particles with the carbon material on a nano-scale.

One non-limiting and exemplary embodiment provides a composite material which contains silicon and a carbon material and in which electrical connections are further stabilized by highly hybridizing the silicon particles with the carbon material on a nano-scale and the destruction of the silicon particles is further suppressed as compared to conventional composite materials containing silicon and a carbon material.

In one general aspect, the techniques disclosed here feature a silicon—carbon composite material containing: a carbon material comprising layers; and silicon particles supported between the layers of the carbon material. The specific surface area of the silicon—carbon composite material is 200 m²/g or more as determined by the Brunauer-Emmett-Teller (BET) method using nitrogen gas adsorption.

According to the present disclosure, the following material can be provided: a composite material which contains silicon and a carbon material and in which electrical connections are further stabilized by highly hybridizing the silicon particles with the carbon material on a nano-scale and the destruction of the silicon particles is further suppressed as compared to conventional composite materials containing silicon and a carbon material.

It should be noted that general or specific embodiments may be implemented as a material, a device, an apparatus, a system, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an X-ray diffraction chart for Sample 3 obtained in Example 1A, Sample 9 obtained in Example 1B, and Sample 6 obtained in Reference Example 1;

FIG. 2A is a scanning electron microscope (SEM) image of Sample 3 obtained in Example 1A;

FIG. 2B is a SEM image of Sample 6 obtained in Reference Example 1;

FIG. 3A is a graph showing the relationship between the discharge capacity of each of laminated half-cells obtained in Examples 3A and 3B and Reference Example 3 and the number of cycles;

FIG. 3B is a graph showing the relationship between the discharge capacity retention of each of the laminated half-cells obtained in Examples 3A and 3B and Reference Example 3 and the number of cycles;

FIG. 4 is a sectional view of a lithium ion battery according to an embodiment of the present disclosure;

FIG. 5 is a perspective view of the lithium ion battery shown in FIG. 4; and

FIG. 6 is a flowchart showing a producing method according to an embodiment of the present disclosure.

### DETAILED DESCRIPTION

### Underlying Knowledge Forming Basis of the Present Disclosure

As a result of investigations by the inventor, it has become clear that a composite material containing silicon particles and a carbon material highly mixed together on a nano-scale cannot be synthesized by the method disclosed in the patent document. In the case of mechanically mixing a carbon material such as graphite with nano-silicon in a ball mill, no highly dispersed composite in which nano-sized silicon particles (nano-silicon) and the carbon material are hybridized together on a nano-scale is obtained and the size of silicon particles is on the order of microns (μm). This is because when the size of silicon particles is on the order of nanometers, the silicon particles are likely to aggregate and it is difficult to crush the aggregated silicon particles. Furthermore, in the case where nano-silicon and a pyrolytic resin are mixed together and the pyrolytic resin is carbonized by heat treatment in a non-oxidizing atmosphere, silicon particles are likely to aggregate. It is difficult that the aggregated silicon particles are crushed and are uniformly mixed with the pyrolytic resin. As a result, a non-uniform composite material containing partially aggregated nano-silicon and carbon is obtained. As described above, the following material cannot be obtained by any conventional method: a silicon—carbon composite material in which electrical connections are sufficiently stabilized by highly hybridizing silicon particles with a carbon material on a nano-scale and the destruction of the silicon particles is sufficiently suppressed.

A first aspect of the present disclosure provides a silicon—carbon composite material containing:
a carbon material comprising layers; and
silicon particles supported between the layers of the carbon material,
wherein the specific surface area of the silicon—carbon composite material is 200 m²/g or more as determined by the BET method using nitrogen gas adsorption.

According to the first aspect, the following material can be provided: a composite material in which electrical connections are further stabilized by highly hybridizing silicon particles with a carbon material on a nano-scale and the destruction of the silicon particles is further suppressed as compared to conventional composite materials containing silicon and a carbon material. The silicon—carbon composite material according to the first aspect has a structure in which, for example, electrical connection failures are unlikely to be caused by the change in volume of the silicon particles due to the intercalation of lithium ions and the silicon particles are unlikely to be destroyed.

In a second aspect of the present disclosure, for example, two or more of the silicon particles may be supported between two adjacent layers of the carbon material in the silicon—carbon composite material according to the first aspect.

In a third aspect of the present disclosure, the specific surface area of the silicon—carbon composite material according to the first or second aspect may be, for example, less than 500 m²/g. In the silicon—carbon composite material according to the third aspect, the number of the silicon particles in direct contact with, for example, an electrolyte solution is small and a solid-electrolyte interface (SEI) that causes the reduction in capacity of a lithium-ion battery is suppressed. In the silicon—carbon composite material according to the third aspect, the carbon material having the layered structure has few portions separated in the form of a graphene oxide. That is, there are few oxygen-containing groups, such as hydroxy groups, epoxy groups, and carboxy groups, derived from the graphene oxide and therefore, for example, the increase in irreversible capacity of a lithium-ion battery can be suppressed.

In a fourth aspect of the present disclosure, the silicon—carbon composite material according to any one of the first to third aspects may further contain, for example, amorphous carbon. According to the fourth aspect, the conductivity of the silicon—carbon composite material can be increased. That is, electrical connections between the silicon particles in an electrode material containing the silicon—carbon composite material and between carbon and the silicon particles are further stabilized.

A fifth aspect of the present disclosure provides a lithium-ion battery including a negative electrode containing the silicon—carbon composite material according to any one of the first to fourth aspects and a positive electrode. According to the fifth aspect, the following battery can be provided: a lithium-ion battery including a negative electrode with electrical connections stable to the change in volume of the silicon particles due to the intercalation of lithium ions.

A sixth aspect of the present disclosure provides a method for producing a silicon—carbon composite material, the method including:
mixing a graphite oxide with an alkyl amine or a cationic surfactant to preparing a graphite oxide having a layered structure;
preparing a composite of a carbon material having a layered structure and a siloxane from the graphite oxide having the layered structure and an organic silicon compound;
reducing the siloxane into silicon by performing heat treatment to the composite of the carbon material having the layered structure and the siloxane in a non-oxidizing atmosphere containing a magnesium vapor; and
removing a component material other than the silicon and carbon from a composite including the silicon and the carbon material having the layered structure,
wherein the alkyl amine or the cationic surfactant contains an alkyl group containing 12 to 18 carbon atoms.

According to the sixth aspect, the silicon particles and the carbon material can be highly hybridized together on a nano-scale. This enables the silicon—carbon composite material, in which the silicon particles are supported between layers of the silicon—carbon composite material, to be obtained. Furthermore, the following material can be obtained: a composite material in which the volume ratio of an oxide layer on the surface of each silicon particle, the oxide layer not contributing to charge or discharge, to the silicon particle is small.

In a seventh aspect of the present disclosure, in the method according to the sixth aspect, the organic silicon compound is, for example, an alkoxysilane containing no alkyl group. According to the sixth aspect, for example, a composite material containing no Si—CH₃ bond can be obtained.

In an eighth aspect of the present disclosure, in the method according to the sixth or seventh aspect, the component material other than the silicon and the carbon may be removed in such a manner that the composite including the silicon and the carbon material having the layered structure is washed with, for example, an aqueous solution of acid or an ammonium salt. According to the eighth aspect, the component material other than silicon and carbon can be efficiently removed.

In a ninth aspect of the present disclosure, in the method according to the sixth or seventh aspect, the component material other than the silicon and the carbon may be removed in such a manner that the composite including the silicon and the carbon material having the layered structure is heat-treated in a non-oxidizing atmosphere. According to the ninth aspect, Mg₂Si can be decomposed.

Embodiments of the present disclosure are described below. Descriptions below relate to an example of the present disclosure. The present disclosure is not limited to the descriptions.

A composite material according to an embodiment of the present disclosure contains a carbon material having a layered structure and silicon particles supported between layers of the carbon material.

The carbon material is not particularly limited and may have the layered structure. The carbon material used may be, for example, graphite.

The silicon particles are supported between the layers of the carbon material. The specific surface area of the composite material is 200 m²/g or more as determined by the BET method using nitrogen gas adsorption. The composite material, which has such a large specific surface area, has a structure in which the silicon particles and the carbon material are highly hybridized together on a nano-scale. In the composite material, since the silicon particles are supported between the layers of the carbon material having the layered structure, the interlayer distance of the carbon material is large. When the composite material has a specific surface area of less than 200 m²/g, the silicon particles are supported on end portions and surface portions of the carbon material having the layered structure and are not sufficiently supported between the layers of the carbon material having the layered structure and the interlayer distance is less than the former one. As the interlayer distance of the carbon material is larger, the amount of an adsorbed nitrogen gas tends to be larger and the specific surface area tends to be larger.

Since the composite material has a structure in which the silicon particles are supported between the layers of the carbon material having the layered structure and the silicon particles and the carbon material are highly hybridized together, electrical connection failures are unlikely to be caused by the change in volume of the silicon particles due to the intercalation of lithium ions in the case where the composite material is used as, for example, a negative electrode material for lithium ion batteries. The silicon particles have a size on the order of nanometers and the concentration of lithium ions in the silicon particles is unlikely to be non-uniform. Therefore, the destruction of the silicon particles is suppressed. Incidentally, as described in the paragraphs of “Description of the Related Art”, in the case where silicon is used as a negative electrode material for lithium ion batteries, it is important that the silicon particles are nano-sized and the silicon particles and the carbon material are highly hybridized together on a nano-scale. The composite material meets these requirements.

The upper limit of the specific surface area of the composite material is not particularly limited and is, for example, less than 500 m²/g. When the specific surface area of the composite material less than 500 m²/g, the number of the silicon particles in direct contact with, for example, an electrolyte solution is small and the formation of a SEI can be suppressed. Therefore, the reduction in capacity of a lithium-ion battery is suppressed. Furthermore, the carbon material having the layered structure has few portions separated in the form of a graphene oxide. That is, there are few oxygen-containing groups, such as hydroxy groups, epoxy groups, and carboxy groups, derived from the graphene oxide and therefore, for example, the increase in irreversible capacity of a lithium-ion battery can be suppressed.

The size of the silicon particles is not particularly limited. The silicon particles, which are supported between the layers of the carbon material, have a size on the order of, for example, nanometers. The silicon particles, which are supported between the layers of the carbon material, have a primary particle size of, for example, 3 nm or more and a secondary particle size of 50 nm or less. The primary particle size of the silicon particles is, for example, less than 20 nm. Herein, the primary particle size of the silicon particles refers to the size of primary particles of silicon. The secondary particle size of the silicon particles refers to the size of secondary particles formed by the aggregation of primary particles of silicon. The average primary particle size of the silicon particles, which are supported between the layers of the carbon material, may be 3 nm or more. The average secondary particle size of the silicon particles may be 50 nm or less. Furthermore, the average primary particle size of the silicon particles may be less than 20 nm. In the present disclosure, the average primary particle size and average secondary particle size of the silicon particles are the averages calculated from the measurements obtained by measuring the primary particle size and secondary particle size of arbitrary 100 of the silicon particles contained in the composite material using a transmission electron microscope (TEM) image. The primary particle size and the secondary particle size can be calculated in the form of the diameter of a circle having the same area as the area of each silicon particle in an obtained image.

When the silicon particles have the above size, for example, the concentration distribution of lithium ions in the silicon particles is unlikely to be non-uniform. That is, when the lithium ions diffuse in the silicon particles, the difference in lithium ion concentration between the surface and inside of each silicon particle is unlikely to be large. Therefore, the silicon particles are unlikely to be destroyed. This enables the deterioration of the capacity of a lithium-ion battery to be suppressed.

The composite material may further contain amorphous carbon. Amorphous carbon can be added by, for example, a method in which carbon black, which is amorphous carbon, is mixed with a silicon—carbon composite material or a method in which a resin converted into amorphous carbon by pyrolysis is mixed with the silicon—carbon composite material and is then pyrolyzed. In the case of the latter method, the resin is not particularly limited and may be, for example, polyvinyl alcohol (PVA), polyvinylidene fluoride (PVDF), polyvinyl chloride (PVC), or the like. Amorphous carbon serves as a conductive aid. Therefore, when the composite material further contains amorphous carbon, the electrical connection between the silicon particles and the electrical connection between the silicon particles and the carbon material having the layered structure are further stabilized in an electrode material.

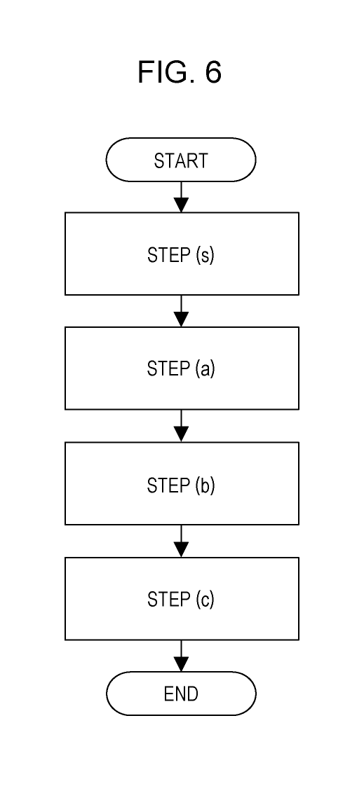

An example of a method for producing the composite material is described below. The method for producing the composite material includes Step (s) of expanding the interlayer distance of a graphite oxide having a layered structure by mixing the graphite oxide with an alkyl amine or a cationic surfactant, Step (a) of preparing a composite of the carbon material having the layered structure and a siloxane from the graphite oxide having the layered structure and an organic silicon compound, Step (b) of reducing the siloxane into silicon by heat-treating the obtained composite in a non-oxidizing atmosphere containing a magnesium vapor, and Step (c) of removing a component material other than silicon and carbon. The alkyl amine or cationic surfactant used in Step (s) contains an alkyl group containing 12 to 18 carbon atoms. Steps (s) and (a) to (c) may be performed in the order shown in a flowchart in FIG. 6. Producing the composite material by the above producing method enables the silicon particles and the carbon material to be highly hybridized together on a nano-scale. In the producing method, the silicon particles are prepared by reducing the siloxane into nano-silicon. Therefore, very few oxide layers are present on the surface of each silicon particle.

In the producing method, the graphite oxide is made from graphite. The graphite used may be natural or synthetic graphite. The graphite oxide can be obtained by oxidizing the graphite. A method for oxidizing the graphite is, for example, a known chemical or electrochemical method such as the Hummers method, the Brodie method, or the Staudenmaier method. Oxygen-containing groups such as hydroxy groups, epoxy groups, and carboxy groups are present between layers of the graphite oxide or end portions thereof. The graphite oxide contains hydroxy groups and therefore a composite in which a siloxane is immobilized between the layers of the graphite oxide can be prepared as described below.

Before the organic silicon compound is added to the obtained graphite oxide, the alkyl amine or the cationic surfactant is added thereto. The alkyl amine or the cationic surfactant contains the alkyl group containing 12 to 18 carbon atoms. The alkyl amine or the cationic surfactant, which contains such a long alkyl group, penetrates between the layers of the graphite oxide to expand the interlayer distance thereof, thereby allowing the organic silicon compound to readily penetrate between the layers thereof.

The alkyl amine or the cationic surfactant is not particularly limited and may contain the alkyl group containing 12 to 18 carbon atoms. The alkyl amine or the cationic surfactant is an amine or cationic surfactant, respectively, containing, for example, a dodecyl group (C12), a tetradecyl group (C14), a hexadecyl group (C16), or an octadecyl group (C18). Examples of the alkyl amine include dodecyl amine, tetradecyl amine, hexadecyl amine, and octadecyl amine. Examples of the cationic surfactant include dodecyltrimethylammonium bromide, tetradecyltrimethylammonium bromide, hexadecyltrimethylammonium bromide, octadecyltrimethylammonium bromide, dodecyltrimethylammonium chloride, tetradecyltrimethylammonium chloride, hexadecyltrimethylammonium chloride, and octadecyltrimethylammonium chloride. The BET specific surface area of the obtained composite material varies depending on the number of carbon atoms in the alkyl group in the alkyl amine or cationic surfactant used.

In the case of using the alkyl amine, a graphite oxide powder is immersed in a solution prepared by dissolving the alkyl amine in an organic solvent such as hexane, whereby the graphite oxide in which the alkyl amine is interposed between the layers of the graphite oxide can be obtained. In the case of using the cationic surfactant, an aqueous solution of the cationic surfactant is mixed with the graphite oxide, followed by filtration and drying, whereby the graphite oxide in which the cationic surfactant is interposed between the layers of the graphite oxide can be obtained. Alternatively, before the aqueous solution of the cationic surfactant is mixed with the graphite oxide, the graphite oxide may be mixed with an aqueous solution of sodium hydroxide in advance, followed by ultrasonic dispersion. Mixing the graphite oxide with the aqueous sodium hydroxide solution increases the dispersibility of the graphite oxide.

Next, the organic silicon compound is added to the graphite oxide. The organic silicon compound, which is used in the producing method, is not particularly limited. Typical examples of the organic silicon compound include silicon compounds, such as alkoxysilanes and chlorosilanes, containing a hydrolyzable functional group. Alkoxysilanes generally used are methoxysilanes containing a methoxy group (—OCH₃) and ethoxysilanes containing an ethoxy group (—OCH₂CH₃).

The organic silicon compound may be an alkoxysilane containing no alkyl group. Examples of the alkoxysilane containing no alkyl group (an alkoxysilane containing no alkyl group directly bonded to a silicon atom) include tetramethyl orthosilicate (Si(OCH₃)₄), tetraethyl orthosilicate (Si(OC₂H₅)₄), tetrapropyl orthosilicate (Si(OC₃H₇)₄), and tetrabutyl orthosilicate (Si(OC₄H₉)₄). In the case of using an alkoxysilane, such as methyltriethoxysilane (CH₃Si(OC₂H₅)₃) or 3-aminopropylmethyldiethoxysilane (H₂N(CH₂)₃Si(CH₃)(OC₂H₅)₂), containing an alkyl group, an Si—C bond is not broken at a temperature of lower than about 700° C. and therefore no silicon is obtained in some cases because the Si—C bond remains without being broken in a reduction reaction using an Mg vapor below.

In this embodiment, the composite of the carbon material having the layered structure and the siloxane can be prepared in such a manner that the organic silicon compound is added to the graphite oxide and functional groups of the organic silicon compound are hydrolyzed, followed by dehydrocondensation. Hydroxy groups (—OH) are formed by hydrolyzing the functional groups of the organic silicon compound. Subsequently, the hydroxy groups are subjected to dehydrocondensation, whereby a siloxane containing a siloxane bond (Si—O—Si) is formed. When the siloxane is formed, hydroxy groups contained in the graphite oxide and hydroxy groups of some silicon compounds undergo dehydrocondensation and a bond (C—O—Si) between carbon in the graphite oxide and the siloxane is formed. Therefore, the formed siloxane combines with the graphite oxide and is immobilized between the layers of the graphite oxide.

Conditions for hydrolyzing the organic silicon compound and subjecting the organic silicon compound to dehydrocondensation are not particularly limited. For example, the graphite oxide having expanded interlayer distance, the organic silicon compound, an organic solvent, and water are mixed together, followed by stirring at a temperature ranging from room temperature to 80° C., whereby the organic silicon compound is hydrolyzed. The organic solvent used may be, for example, toluene or the like. Thereafter, unreacted silicon compounds and the organic solvent are removed from the graphite oxide by a process such as centrifugation or filtration and the graphite oxide is dried, whereby silicon compounds are subjected to dehydrocondensation, so that the siloxane is obtained.

The composite of the carbon material having the layered structure and the siloxane may be heat-treated before the reduction reaction is carried out. Performing the heat treatment allows the reduction reaction of oxygen-containing groups contained in the graphite oxide and the dehydrocondensation reaction of unreacted hydroxy groups to proceed. Conditions for the heat treatment are not particularly limited and include, for example, conditions for treatment at 500° C. in a vacuum atmosphere. The heat treatment may be performed simultaneously with the reduction reaction.

In this embodiment, the siloxane is reduced into silicon by heat-treating the siloxane in the presence of a magnesium vapor. In this embodiment, particle growth due to the diffusion of the silicon particles is suppressed by reducing the siloxane immobilized between the layers of the graphite oxide into silicon and therefore the silicon particles are unlikely to be coarsened.

Magnesium has a very high vapor pressure (372 Pa) at the melting point (650° C.) thereof. Heat-treating the composite of the carbon material and the siloxane in the presence of the magnesium vapor allows the following chemical reaction to proceed, so that the siloxane is reduced into silicon:

2Mg+SiO₂→2MgO+Si

Conditions for the heat treatment are not particularly limited. As the temperature is higher and the pressure of the magnesium vapor is higher, the efficiency of the reduction reaction is higher. However, in the case where the heat treatment is performed at a temperature significantly higher than the melting point of magnesium, melted magnesium aggregates and therefore the surface area of magnesium that evaporates decreases. Thus, it is effective to perform the heat treatment at a temperature close to the melting point of magnesium.

The morphology of the magnesium used in this embodiment is not particularly limited and the magnesium vapor may be generated. For example, powdery, granular, ribbon-shaped, rod-shaped, or pellet-shaped magnesium can be used. The magnesium may be mixed with the above-mentioned composite in a graphite or stainless steel vessel, followed by heat treatment.

In this embodiment, the heat treatment is performed in the non-oxidizing atmosphere. In the present disclosure, the non-oxidizing atmosphere is a vacuum or an inert gas atmosphere such as a nitrogen atmosphere or an argon atmosphere. In the case of an oxidizing atmosphere, the generated magnesium vapor is oxidized into magnesium oxide (MgO) or magnesium dioxide (MgO₂) and therefore the siloxane is not sufficiently reduced.

As described above, MgO is contained in the composite material containing silicon reduced by the magnesium vapor and the carbon material in addition to silicon and the carbon material. When the equivalent of magnesium is more than the equivalent of the siloxane, not only unreacted Mg remains and magnesium silicide (Mg₂Si) is produced in some cases as indicated by the following reaction equation:

4Mg+SiO₂→Mg₂Si+2MgO

When the equivalent of magnesium is less than the equivalent of the siloxane, MgO₂ is further produced in some cases as indicated by the following reaction equation:

Mg+SiO₂→MgO₂+Si

As described above, in the reduction reaction using the magnesium vapor, the component material, such as MgO, MgO₂, Mg₂Si, or unreacted Mg, other than silicon and carbon is produced. In this embodiment, the component material other than silicon and carbon may be removed. In the present disclosure, the expression “the component material other than silicon and carbon is removed” means that a treatment for removing the component material other than silicon and carbon is performed and does not mean that the whole of the component material other than silicon and carbon is completely removed. That is, the finally obtained composite material may contain the component material other than silicon and carbon.

In this embodiment, the component material other than silicon and carbon can be removed by washing using an aqueous solution of acid or an ammonium salt.

The aqueous solution of acid or the ammonium salt is not particularly limited. The aqueous solution of acid may be, for example, dilute hydrochloric acid or the like. The aqueous solution of the ammonium salt may be for example, an aqueous ammonium chloride solution or the like.

In the case where Mg₂Si is contained in the composite material containing silicon and the carbon material, when the composite material is washed with dilute hydrochloric acid, Mg₂Si reacts with dilute hydrochloric acid to produce monosilane (SiH₄) in some cases. Monosilane reacts vigorously with oxygen in air to produce silicon dioxide (SiO₂). Thus, in the case where Mg₂Si is contained in the composite material, it is effective that Mg₂Si is decomposed by heat treatment in a non-oxidizing atmosphere in advance. Conditions for heat treatment are not particularly limited and heat treatment may be performed at, for example, 650° C. in a vacuum atmosphere. Mg₂Si is decomposed by heat treatment, so that Mg evaporates and Si crystallizes.

In the method for producing the composite material, a treatment for adding amorphous carbon may be performed. Adding amorphous carbon to the composite material further stabilizes electrical connections between the silicon particles and electrical connections between the silicon particles and the carbon material having the layered structure because amorphous carbon serves as a conductive aid. A method for adding amorphous carbon is not particularly limited. The following method is cited: for example, a method in which the composite material is mechanically mixed with carbon black or a method in which the composite material is mixed with resin and the resin is converted into amorphous carbon by pyrolysis. The above resin is not particularly limited and may be, for example, polyvinyl alcohol (PVA), polyvinylidene fluoride (PVDF), polyvinyl chloride (PVC), furfuryl alcohol (FFA), or the like.

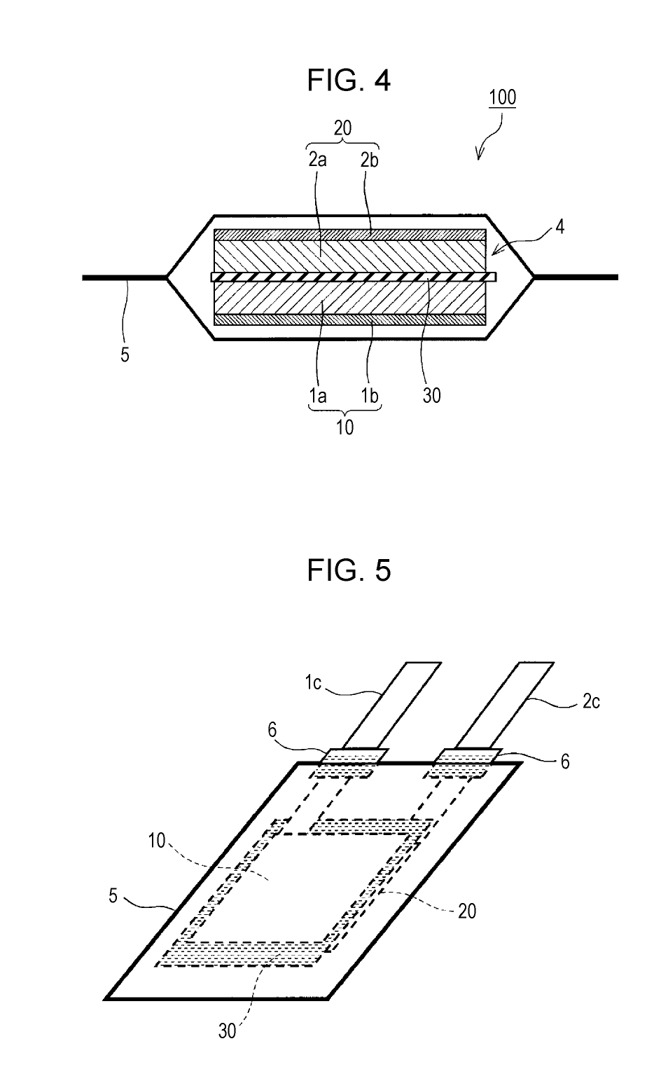

A lithium-ion battery 100 according to an embodiment of the present disclosure includes a negative electrode 20 containing the above-mentioned silicon—carbon composite material and a positive electrode 10. As shown in FIG. 4, the lithium-ion battery 100 further includes an electrode group 4 and an enclosure 5. The electrode group 4 is housed in the enclosure 5. The electrode group 4 includes the positive electrode 10, the negative electrode 20, and a separator 30. The positive electrode 10 and the negative electrode 20 face each other with the separator 30 therebetween. The positive electrode 10 includes a positive electrode mix layer 1a and a positive electrode current collector 1b. The positive electrode mix layer 1a is placed between the positive electrode current collector 1b and the separator 30. The negative electrode 20 includes a negative electrode mix layer 2a and a negative electrode current collector 2b. The negative electrode mix layer 2a is placed between the negative electrode current collector 2b and the separator 30. The electrode group 4 is impregnated with an electrolyte solution (not shown) containing a lithium salt.

As shown in FIG. 5, the positive electrode current collector 1b of the positive electrode 10 is connected to a positive electrode tab lead 1c. The negative electrode current collector 2b of the negative electrode 20 is connected to a negative electrode tab lead 2c. The positive electrode tab lead 1c and the negative electrode tab lead 2c extend outside the enclosure 5. An insulating tab film 6 is placed between the positive electrode tab lead 1c and the enclosure 5. Another insulating tab film 6 is placed between the negative electrode tab lead 2c and the enclosure 5.

The positive electrode mix layer 1a contains a positive electrode active material capable of storing and releasing lithium ions. Examples of the positive electrode active material include lithium cobaltate and lithium metal composite oxides. The positive electrode mix layer 1a may contain a conductive aid, an ion conductor, and a binder as required. The positive electrode active material, the conductive aid, the ion conductor, and the binder may be known materials.

The positive electrode current collector 1b may be a sheet or film prepared from a metal material. The positive electrode current collector 1b may be porous or poreless.

The negative electrode mix layer 2a contains the above-mentioned silicon—carbon composite material. That is, in the negative electrode mix layer 2a, a negative electrode active material contains the silicon particles. The negative electrode mix layer 2a may contain a conductive aid, an ion conductor, and a binder as required. The positive electrode active material, the conductive aid, the ion conductor, and the binder may be known materials.

The negative electrode current collector 2b may be a sheet or film prepared from a metal material. The negative electrode current collector 2b may be porous or poreless.

The separator 30 may be a porous membrane prepared from polyethylene, polypropylene, glass, cellulose, ceramic, or the like. The electrolyte solution is contained in pores of the separator 30.

The electrolyte solution contains, for example, a nonaqueous solvent and the lithium salt dissolved in the nonaqueous solvent. Examples of the nonaqueous solvent include cyclic carbonate solvents, linear carbonate solvents, cyclic ether solvents, linear ether solvents, cyclic ester solvents, linear ester solvents, and fluorine-based solvents. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃.

The shape of the lithium-ion battery 100 is not limited to a sheet shape shown in FIGS. 4 and 5. The lithium-ion battery 100 may be, for example, coin-shaped, button-shaped, laminated, cylindrical, flat, or rectangular.

Since the negative electrode 20 contains the above-mentioned silicon—carbon composite material, the lithium-ion battery 100 has electrical connections stable to the change in volume of the silicon particles due to the intercalation of lithium ions. The lithium-ion battery 100 has both high capacity and high durability.

The lithium-ion battery 100 has increased capacity because the negative electrode active material contains the silicon particles. In addition, good electrical connections are maintained in the negative electrode active material even in the case where the negative electrode active material stores lithium ions and therefore the volume of the silicon particles varies. Therefore, the lithium-ion battery 100 has high durability.

A method for manufacturing the lithium-ion battery 100 is not particularly limited. A known method can be directly used to manufacture the lithium-ion battery 100. An ion capacitor may be configured to include a negative electrode containing the silicon—carbon composite material and a positive electrode (for example, activated carbon or the like). That is, an electrochemical device (a lithium-ion battery, an ion capacitor, or the like) may be configured to include a negative electrode containing the silicon—carbon composite material and a positive electrode.

### EXAMPLES

The present disclosure is further described below in detail with reference to examples. The present disclosure is not in any way limited to the examples.

### Example 1A

Fuming nitric acid and potassium chlorate were added to scaly natural graphite with an average size of 45 μm and the scaly natural graphite was oxidized at 60° C. for 3 hours, followed by water washing, filtration, and drying, whereby a graphite oxide (GO) was obtained (the Brodie method).

Next, 1,200 mg of the graphite oxide was mixed with 240 ml of a 0.05 N aqueous solution of NaOH, followed by ultrasonic dispersion for 15 minutes, whereby an aqueous dispersion of the graphite oxide (an aqueous graphite oxide dispersion) was prepared. On the other hand, 4,800 mg of hexadecyltrimethylammonium bromide (C16TAB) was mixed with 1,200 ml of water, followed by stirring, whereby an aqueous solution of C16TAB was prepared.

Next, the prepared aqueous graphite oxide dispersion and aqueous C16TAB solution were mixed together, followed by stirring, water washing, filtration, and drying whereby a graphite oxide (C16TAB/GO) powder in which C16TAB was intercalated between layers of the graphite oxide was obtained.

After 4.4 g of the C16TAB/GO powder was put in an airtight glass vessel and 2.3 ml of water and 700 ml of toluene were added to the airtight glass vessel and were stirred at room temperature for 1 hour, 22.2 ml of tetraethyl orthosilicate (Si(OC₂H₅)₄) was added to the airtight glass vessel, followed by stirring at 80° C. for 100 hours. Thereafter, the contents were washed with toluene and acetone using a centrifuge, followed by drying, whereby a composite of a carbon material having a layered structure and a siloxane was obtained.

Next, 1,500 mg of the composite was weighed, added to a stainless steel boat, and was then vacuum-heated at 500° C. for 1 hour, whereby Sample 1 was obtained. The weight of Sample 1 was 1,000 mg.

Thereafter, 100 mg of Sample 1 and 79 mg of a magnesium powder (a particle size of 180 μm or less) were mixed together in an airtight metal vessel equipped with a vacuum ventilation line and a stop valve and were sealed therein, followed by vacuum-evacuating the airtight metal vessel. Next, the airtight metal vessel was heated at 650° C. for 6 hours in such a manner that a nitrogen gas was being supplied to the outside of the airtight metal vessel, whereby Sample 2 was obtained. Next, 80 ml of 1 M hydrochloric acid was added to Sample 2, followed by stirring for 12 hours, water washing, and filtration, whereby residue was obtained. The residue was dried, whereby Sample 3 which was a silicon—carbon composite material was obtained.

Next, the weight ratio between silicon and carbon in Sample 3 was investigated. One hundred milligrams of Sample 3 was weighed, was put in an alumina boat, and was then heat-treated at 1,000° C. for 6 hours in air, whereby carbon in Sample 3 was oxidized and silicon (Si) in Sample 3 was oxidized into silicon dioxide (SiO₂). The weight of obtained silicon dioxide was 105 mg. The number of moles of SiO₂ was calculated from the weight of the silicon dioxide. Supposing that the same number of moles of Si was present in untreated Sample 3, the weight of Si was 49 mg. That is, the weight ratio of carbon to silicon in Sample 3 was 51:49.

### Example 1B

A graphite oxide (C16TAB/GO) powder was prepared by the same method as that used in Example 1A. After 4.4 g of this powder was put in an airtight glass vessel and 2.3 ml of water and 700 ml of toluene were added to the airtight glass vessel and were stirred at room temperature for 1 hour, 44.0 ml of tetraethyl orthosilicate (Si(OC₂H₅)₄) was added to the airtight glass vessel, followed by stirring at 80° C. for 100 hours. Thereafter, the contents were washed with toluene and acetone using a centrifuge, followed by drying, whereby a composite of a carbon material having a layered structure and a siloxane was obtained. Thereafter, the composite was vacuum-heated by the same method as that used in Example 1A. Next, the composite was mixed with a magnesium powder and the mixture was heat-treated and was then treated with hydrochloric acid, whereby Sample 9 was obtained. The weight ratio between silicon and carbon in Sample 9 was investigated by the same method as that used in Example 1A. As a result, the weight ratio of carbon to silicon was 51:49.

The following is a reference example of a silicon—carbon composite material prepared under conditions described in an application (Japanese Patent Application No. 2015-125768) filed by the applicant.

### Reference Example 1

One thousand two hundred milligrams of a graphite oxide prepared by a method similar to that used in Example 1A was weighed and was moved into a vial bottle with a screw cap. After 24 ml of n-butylamine was added to the vial bottle, the screw cap was tightened, followed by heat treatment at 60° C. for 3 hours. The vial bottle was returned to room temperature and 2.2 ml of water and 150 ml of toluene were added to the vial bottle, followed by stirring at room temperature for 1 hour. Thereafter, 22 ml of tetraethyl orthosilicate (Si(OC₂H₅)₄) was added to the vial bottle, followed by stirring at 80° C. for 100 hours. Thereafter, the contents were washed with toluene and acetone using a centrifuge, followed by drying, whereby a composite of a carbon material having a layered structure and a siloxane was obtained.

Next, 1,500 mg of the composite was weighed, was added to a stainless steel boat, and was then vacuum-heated at 500° C. for 1 hour, whereby Sample 4 was obtained. The weight of Sample 4 was 1,160 mg.

Thereafter, 100 mg of Sample 4 and 79 mg of a magnesium powder (a particle size of 180 μm or less) were mixed in an airtight metal vessel equipped with a vacuum ventilation line and a stop valve and were sealed therein, followed by vacuum-evacuating the airtight metal vessel. Next, the airtight metal vessel was heated at 650° C. for 6 hours in such a manner that a nitrogen gas was being supplied to the outside of the airtight metal vessel, whereby Sample 5 was obtained.

Next, 80 ml of 1 M hydrochloric acid was added to Sample 5, followed by stirring for 12 hours, water washing, and filtration, whereby residue was obtained. The residue was dried, whereby Sample 6 which was a silicon—carbon composite material was obtained.

Next, the weight ratio of carbon to silicon in Sample 6 was investigated by a method similar to that used in Example 1A and was found to be 55:45.

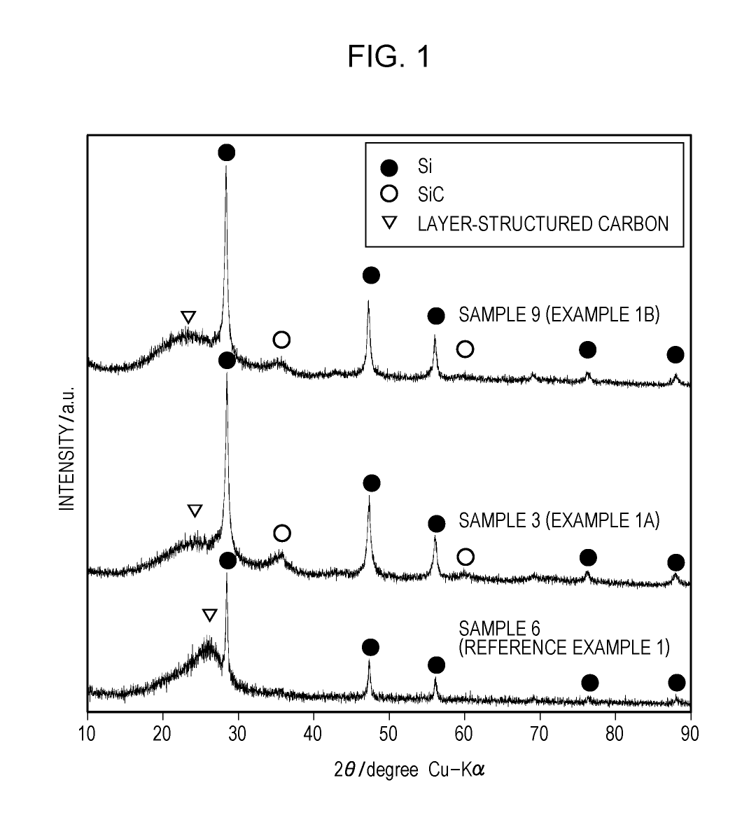

Sample 3, which was obtained in Example 1A, Sample 9, which was obtained in Example 1B, and Sample 6, which was obtained in Reference Example 1, were analyzed by X-ray diffraction using Cu-Kα radiation. An analysis chart is shown in FIG. 1. Peaks originating from silicon (Si) and a peak originating from layer-structured carbon were observed from each of Samples 3, 9, and 6. In Sample 3, the position (diffraction angle) of the peak originating from layer-structured carbon was 24.66° in 2θ. In Sample 9, the position (diffraction angle) of the peak originating from layer-structured carbon was 23.06° in 2θ. In Sample 6, the position (diffraction angle) of the peak originating from layer-structured carbon was 25.75° in 2θ. Furthermore, the interlayer distance of each carbon material having the layered structure was calculated from the diffraction angle. The interlayer distance of Sample 3 was 0.361 nm. The interlayer distance of Sample 9 was 0.390 nm. The interlayer distance of Sample 6 was 0.346 nm. This shows that the interlayer distance of each of Samples 3 and 9 is greater than that of Sample 6. Slight peaks originating from SiC were observed from each of Samples 3 and 9. These peaks suggest that Si produced by reducing a siloxane with Mg reacted with C produced by the pyrolysis of C16TAB or C in a graphite oxide.

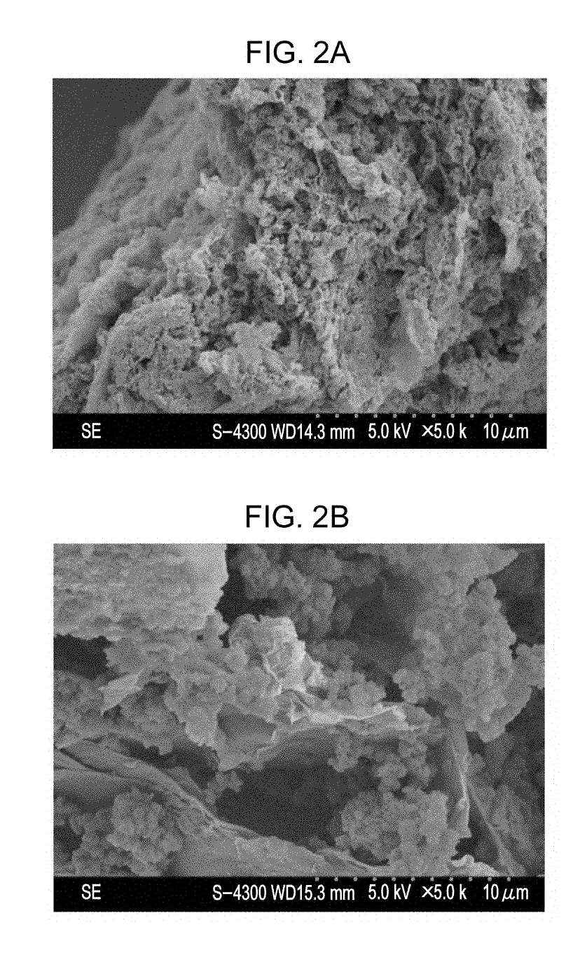

Sample 3, which was obtained in Example 1A, and Sample 6, which was obtained in Reference Example 1, were observed for morphology using a SEM. FIG. 2A is a SEM image of Sample 3. FIG. 2B is a SEM image of Sample 6. FIG. 2A shows that in Sample 3, nano-silicon is highly hybridized with carbon sheets (graphenes) forming a layered structure in such a state that nano-silicon is interposed between the carbon sheets. FIG. 2B shows that in Sample 6, silicon particles are attached to surfaces of a stack of carbon sheets (graphenes). In Sample 6, the number of the silicon particles interposed between the carbon sheets (graphenes) is less than that in Sample 3.

Sample 3, which was obtained in Example 1A, Sample 9, which was obtained in Example 1B, and Sample 6, which was obtained in Reference Example 1, were measured for BET specific surface area using nitrogen adsorption. The measurement results are shown in Table 1. In Sample 3, which was obtained in Example 1A, and Sample 9, which was obtained in Example 1B, nano-silicon is highly hybridized with the carbon sheets, which form the layered structure, as described above. Therefore, the specific surface area of Sample 3 is large, 344 m²/g, and the specific surface area of Sample 9 is large, 466 m²/g. However, in Sample 6, which was obtained in Reference Example 1, the number of the silicon particles interposed between the carbon sheets is less than that in Sample 3. Therefore, the specific surface area of Sample 6 is 168 m²/g and is less than that of Sample 3.

TABLE 1

| | Sample 3 | Sample 9 | Sample 6 |
|---|---|---|---|
| Specific surface area | 344 | 466 | 168 |
| (m²/g) | | | |

### Example 2A

Amorphous carbon was added to Sample 3, which was obtained in Example 1A, as described below. To 0.8 g of polyvinyl alcohol (PVA), 100 ml of water was added, followed by stirring, whereby an aqueous solution of PVA was prepared. Next, 0.5 g of Sample 3 was put in the aqueous solution, followed by vacuum defoaming, drying at 80° C. for 16 hours, and then heating at 600° C. for 6 hours in a nitrogen gas atmosphere, whereby PVA was carbonized into amorphous carbon and Sample 7 which was a silicon—carbon composite material containing amorphous carbon was obtained.

### Example 2B

Sample 10 which was a silicon—carbon composite material containing amorphous carbon was obtained from Sample 9 by substantially the same method as that used in Example 2A except that Sample 9 was used instead of Sample 3.

### Reference Example 2

Sample 8 which was a silicon—carbon composite material containing amorphous carbon was obtained from Sample 6 by substantially the same method as that used in Example 2A except that Sample 6 was used instead of Sample 3.

For Samples 7 and 10, the weight ratio between each carbon material having the layered structure, silicon, and amorphous carbon was determined. Similarly to the above-mentioned method, Sample 7 was heat-treated at 1,000° C. for 6 hours in air, whereby carbon in Sample 7 was oxidized and silicon (Si) in Sample 7 was oxidized into silicon dioxide (SiO₂). The number of moles of SiO₂ was calculated from the weight of obtained silicon dioxide. Supposing that the same number of moles of Si was present in untreated Sample 7, the ratio between the sum of the weight of the carbon material having the layered structure and the weight of amorphous carbon and the weight of silicon was calculated. From the calculated ratio and the weight ratio between silicon and carbon in Sample 3, the weight ratio between the carbon material having the layered structure, silicon, and amorphous carbon was calculated. The calculation results are shown in Table 2. For Sample 8, the ratio between the sum of the weight of the carbon material having the layered structure and the weight of amorphous carbon and the weight of silicon was calculated. From the calculated ratio and the weight ratio between silicon and carbon in Sample 6, the weight ratio between the carbon material having the layered structure, silicon, and amorphous carbon was calculated. The calculation results are shown in Table 2.

TABLE 2

| | Sample 7 | Sample 10 | Sample 8 |
|---|---|---|---|
| Weight ratio | 45.9/44.0/10.1 | 37.1/35.5/27.4 | 47.4/38.8/13.8 |
| (L—C/Si/a-C) | | | |

L—C represents the carbon material having the layered structure, Si represents silicon, and a-C represents amorphous carbon.

### Example 3A

A laminated half-cell for testing a lithium ion battery was prepared using Sample 7 as described below. Sample 7, acetylene black (AB) serving as a conductive aid, and polyvinylidene fluoride (PVDF) serving as a binding agent (binder) were mixed in a mortar at a weight ratio of 85/5/10, followed by adding N-methyl-2-pyrrolidone (NMP), whereby a slurry of an electrode mix was prepared. The slurry was applied to copper foil with a thickness of 10 μm, followed by drying and rolling, whereby an electrode mix film (electrode mix layer) was formed. The total thickness of the rolled electrode mix film and copper foil was 20 μm. Next, the electrode mix film and copper foil were punched into a piece with a size of 20 mm×20 mm and a nickel tab lead was attached to the piece, whereby a working electrode was obtained. The weight of the electrode mix film in the working electrode was 4.4 mg. Lithium foil with a thickness of 42 μm was cut into a piece with a size of 25 mm×25 mm and a nickel tab lead was attached to the piece, whereby a counter electrode was obtained. A separator used was a single polyolefin porous film, “UPORE”, available from Ube Industries, Ltd. The working electrode, the separator, and the counter electrode were stacked; the stack was put in a cell container made from an aluminium-laminated film; 0.3 cm³ of an electrolyte solution was poured into the cell container, followed by impregnation and vacuum defoaming; and the cell container was heat-sealed, whereby the laminated half-cell was obtained. The electrolyte solution used was a 1 M solution (available from Mitsubishi Chemical Corporation) of lithium hexafluorophosphate (LiPF₆) in a solvent mixture of ethylene carbonate (EC) and ethyl methyl carbonate (EMC) mixed at a volume ratio of 1:3.

### Example 3B

A laminated half-cell was obtained by substantially the same method as that used in Example 3A except that Sample 10 was used instead of Sample 7.

### Reference Example 3

A laminated half-cell was obtained by substantially the same method as that used in Example 3A except that Sample 8 was used instead of Sample 7.

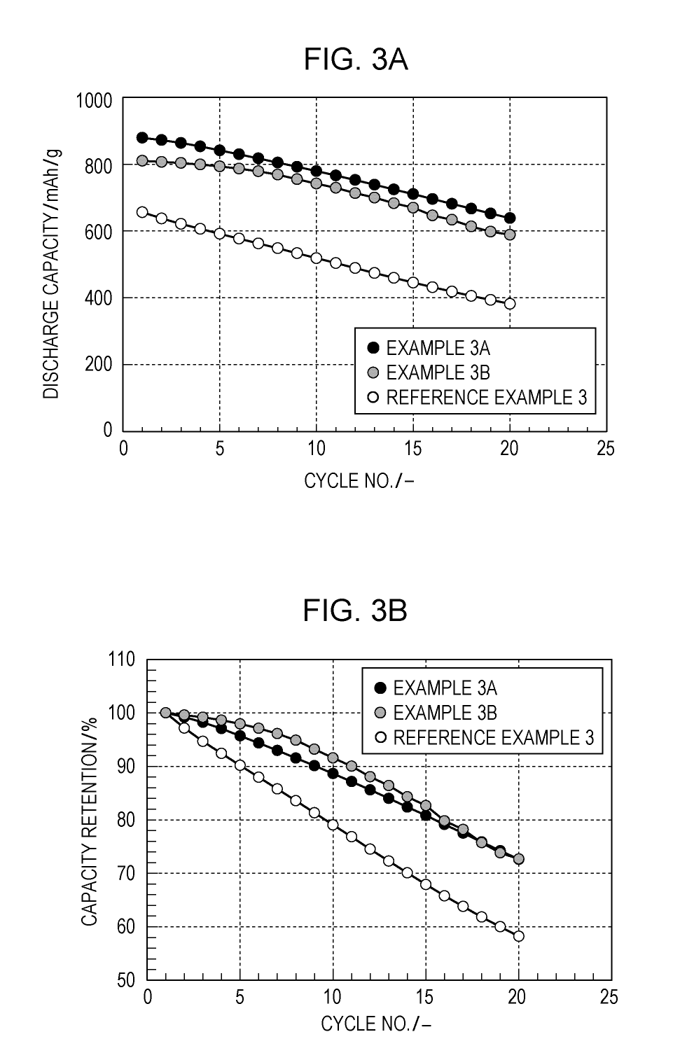

The laminated half-cell obtained in each of Examples 3A and 3B and Reference Example 3 was subjected to a charge/discharge cycle test. Charge and discharge were performed at a constant current of 0.29 mA. The current was cut off at the point in time when the voltage during discharge reached 1.5 V. The cycle test results of the laminated half-cells obtained in Examples 3A and 3B and Reference Example 3 are shown in FIGS. 3A and 3B. FIG. 3A is a graph showing the relationship between the discharge capacity and the number of cycles. FIG. 3B is a graph showing the relationship between the capacity retention and the number of cycles.

As is clear from FIG. 3A, at the same number of cycles, the laminated half-cells obtained in Examples 3A and 3B have higher discharge capacity as compared to the laminated half-cell obtained in Reference Example 3. As is clear from FIG. 3B, at the same number of cycles, the laminated half-cells obtained in Examples 3A and 3B have higher capacity retention as compared to the laminated half-cell obtained in Reference Example 3. These results show that in the electrode mix layer on the working electrode of the laminated half-cell obtained in each of Examples 3A and 3B, nano-silicon and the carbon material having the layered structure are highly hybridized together and electrical connection failures and the destruction of the silicon particles are suppressed.

### INDUSTRIAL APPLICABILITY

A silicon—carbon composite material according to the present disclosure is applicable to a negative electrode material for lithium ion batteries. When a negative electrode of a lithium ion battery contains the silicon—carbon composite material, the lithium ion battery can have both high capacity and high durability.

What is claimed is:

1. A silicon—carbon composite material containing:
a carbon material comprising layers; and
silicon particles supported between the layers of the carbon material,
wherein the specific surface area of the silicon—carbon composite material is 200 m²/g or more as determined by the BET method using nitrogen gas adsorption.

2. The silicon—carbon composite material according to claim 1, wherein two or more of the silicon particles are supported between two adjacent layers of the carbon material.

3. The silicon—carbon composite material according to claim 1, wherein the specific surface area of the silicon—carbon composite material is less than 500 m²/g.

4. The silicon—carbon composite material according to claim 1, further containing amorphous carbon.

5. An electrochemical device comprising a positive electrode and a negative electrode that includes a silicon—carbon composite material containing:
a carbon material comprising layers; and
silicon particles supported between the layers of the carbon material,
wherein the specific surface area of the silicon—carbon composite material is 200 m²/g or more as determined by the BET method using nitrogen gas adsorption.

6. A method for producing a silicon—carbon composite material, the method including:
mixing a graphite oxide with an alkyl amine or a cationic surfactant to prepare a graphite oxide having a layered structure;
preparing a composite of a carbon material having a layered structure and a siloxane from the graphite oxide having the layered structure and an organic silicon compound;
reducing the siloxane into silicon by performing heat treatment to the composite of the carbon material having the layered structure and the siloxane in a non-oxidizing atmosphere containing a magnesium vapor; and
removing a component material other than the silicon and carbon from a composite including the silicon and the carbon material having the layered structure,
wherein the alkyl amine or the cationic surfactant contains an alkyl group containing 12 to 18 carbon atoms.

7. The method for producing the silicon—carbon composite material according to claim 6, wherein the organic silicon compound is an alkoxysilane containing no alkyl group.

8. The method for producing the silicon—carbon composite material according to claim 6, wherein the component material other than the silicon and the carbon is removed in such a manner that the composite including the silicon and the carbon material having the layered structure is washed with an aqueous solution of acid or an ammonium salt.

9. The method for producing the silicon—carbon composite material according to claim 6, wherein the component material other than the silicon and the carbon is removed in such a manner that the composite including the silicon and the carbon material having the layered structure is heat-treated in a non-oxidizing atmosphere.
